(19) United States
(12) Patent Application Publication
(10) Pub. No.: US 2006/0077548 A1
(43) Pub. Date: Apr. 13, 2006

(54) Polarizer

(75) Inventors: Tung-Lung Li, Pingzhen City (TW); Long-Hai Wu, Pingzhen City (TW); Chen-Yung Chang, Pingzhen City (TW)

Correspondence Address: BRUCE H. TROXELL;SUITE 1404, 5205 LEESBURG PIKE, FALLS CHURCH, VA, 22041, US

(73) Assignee: Optimax Technology Corporation

(21) Appl. No.: 10/991,599

(22) Filed: Nov. 19, 2004

(30) Foreign Application Priority Data
Oct. 8, 2004 (TW) 93130476

(51) Int. Cl. G02B 5/30

(52) U.S. Cl. 359/494; 359/483

(57) ABSTRACT

The polarizer of the invention is primarily composed of a retardation layer and a light reflecting layer. Since the retardation layer is capable of providing support to the polarizer and correcting color shifting and the light reflecting layer is capable of enhancing brightness and enlarging viewing angle for an LCD employing the polarizer, the polarizer is not only thinner and lighter than a conventional polarizer, but it also have better brightness and viewing angle, and use less power.

### 1. FIELD OF THE INVENTION

The present invention relates to an improved polarizer, and more particularly, to a polarizer with reduce thickness.

### 2. BACKGROUND OF THE INVENTION

Liquid crystal displays (LCDs) are constructed with polarizer films on their front and rear surfaces to modulate the light rays passing through the liquid crystal layer. Depending on the intended application and ambient lighting conditions, different types of polarizer are used on the rear surface of the LCD panel, which is employed as display for many electronic devices, such as personal digital assistant, notebook computer, and LCD TV, etc.

Following the popularization of LCDs, the demand for polarizer increases since polarizer has become one of the essential elements in LCDs. Hence, as the demand for LCDs increases, the demand for polarizer also increases. Nevertheless, it is noted that polarizer can be used not only in LCDs, but also can be used in other devices.

Please refer to FIG. 1, which is a schematic representation showing the application of a polarizer in an LCD. A common LCD 100 typically include a light source, which produces randomly or unpolarized light, and polarizers 110, 120, which act as filters for filtering the unpolarized light to provide plane polarized light and have optical axes thereof set up 90 degree apart enabling the polarized light passing through the polarizer 110 to be extinguished by the polarizer 120, and a liquid crystal (LC) layer 130, which is sandwiched between the two polarizers 110, 120, wherein the birefringence of the LC layer 130 can be changed by the application of a voltage on the LC layer 130 for enabling the polarized light passing through the polarizer 110 to transmit trough or blocked by the polarizer 120, and as the angle of the LC 130 rotates from 0 to 90 degrees, the amount of light that is transmitted decreases so as to control the brightness of the LCD 100.

It is common to those skilled in the art that he polarizers 110, 120 are both composed of a polarizing film sandwiched by supporting layers, such as transparent substrates.

Nevertheless, in order to compete in the highly competitive market of LCDs, the quality demands for the image displayed by LCDs, such as brightness and chromaticity shifting, are becoming more and more stringent. Hence, the polarizer capable of improving the brightness and chromaticity shifting of LCDs has become the focus point of research.

In view of the above description, the present invention provides an improved polarizer, which can be used in conjunction with LCDs for enabling the same to meet with the stringent quality demands of brightness and chromaticity shifting.

### SUMMARY OF THE INVENTION

It is the primary object of the invention to provide an improved polarizer, which can be used in conjunction with LCDs for enabling the same to meet with the stringent quality demands of brightness and chromaticity shifting.

To achieve the above object, the present invention provide a polarizer, comprising:
a polarizing layer, has a first surface and a second surface opposite to the first surface;
a support layer, disposed on the first surface of the polarizing layer;
a retardation layer, disposed on the second surface of the polarizing layer; and
a light reflecting film, arranged on a surface of the retardation layer opposite to the surface of the retardation layer attaching to the polarizing layer.

In a preferred embodiment of the invention, the support layer is a transparent substrate made of triacetyl cellulose (TAC) and the light reflecting film is a layer of UV-curable polyacrylate.

In addition, the retardation layer is composed of a first retardation plate and a second retardation plate, wherein the first retardation plate is a positive A-plate arranged on a surface of the polarizing layer opposite to the surface of the polarizing layer attaching to the supporting layer, and the second retardation plate is a positive C-plate arranged in a surface of the first retardation plate opposite to the surface of the first retardation plate attaching to the polarizing layer. Moreover, the light reflecting layer is arranged on a surface of the second retardation pate opposite to the surface of the second retardation plate attaching to the first retardation plate.

Let Nx be the refractive index in the X direction, Ny be the refractive index for in the Y direction and Nz be the refractive index in the Z direction, the optical characteristic of the first retardation plate is as following:
Nx>Ny=Nz
and the optical characteristic of the first retardation plate is as following:
Nx=Ny<Nz

### BRIEF DESCRIPTION OF THE DRAWINGS

FIG. 1 is a schematic representation showing the application of a polarizer in an LCD.

FIG. 2A is a schematic illustration showing an improved polarizer according to a preferred embodiment of the present invention.

FIG. 2B is a schematic illustration showing an improved polarizer according to another preferred embodiment of the present invention.

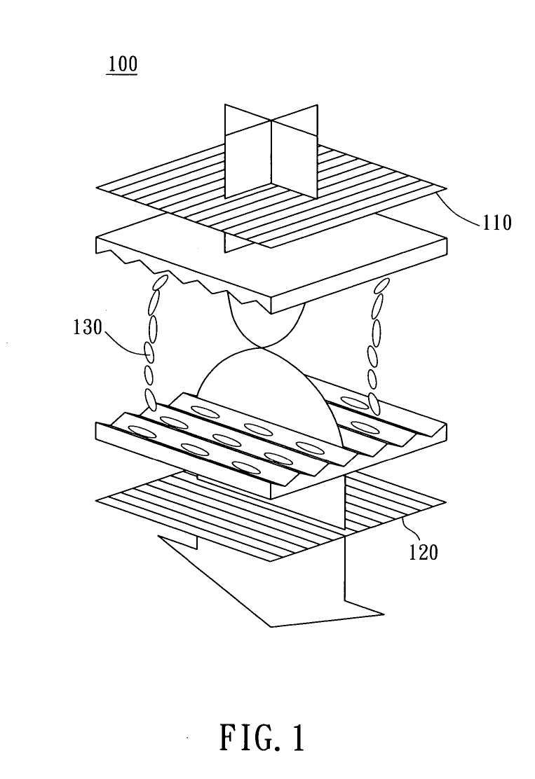

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

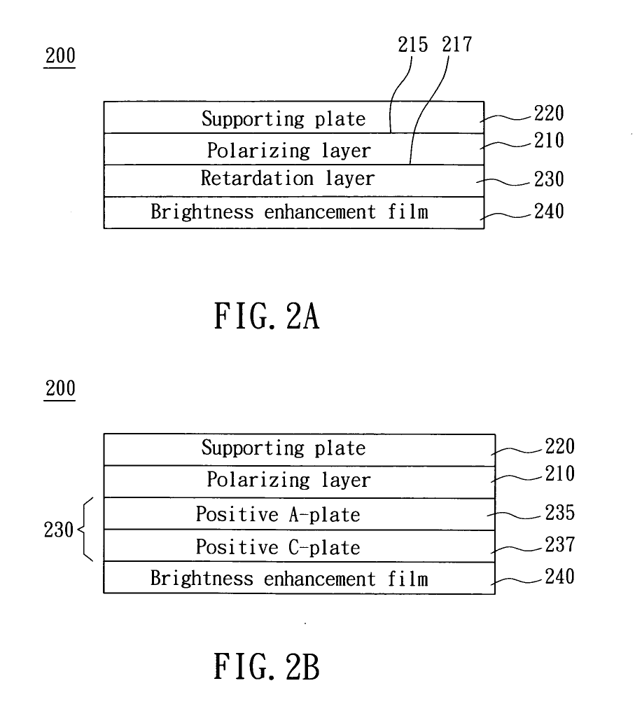

Please refer to FIG. 2A, which is a schematic illustration showing an improved polarizer according to a preferred embodiment of the present invention. As seen in FIG. 2A, the polarizer 200 of the invention comprises:
a polarizing layer 210, has a first surface 215 and a second surface 217 opposite to the first surface;
a support layer 220, disposed on the first layer 215 of the polarizing layer 210;
a retardation layer 230, disposed on the second surface 217 of the polarizing layer 210; and
a light reflecting layer 240, arranged on a surface of the retardation layer 230 opposite to the surface of the retardation layer 230 attaching to the polarizing layer 210.

Moreover, the support layer 220 is a transparent substrate made of material, such as triacetyl cellulose (TAC).

Accordingly, one of the function provided by the retardation layer 230 is to adjust color shifting, that is, it can reduce chromaticity shifting over the field of view while light passing through the polarizer 200. In addition, another function of the retardation layer 230 is to act as the supporting structure of the polarizer 200. By virtue of the retardation layer 230 of the invention, not only the chromaticity shifting can be reduced, but also it enables the polarizer 200 having the retardation layer 230 arranged therein to employ only one support layer 220 disposed on the first surface 215 of the polarizing layer 210 and without require additional support plate to be disposed on the second surface 217, so that the thickness and weight of the polarizer 200 are reduced.

Please to refer to FIG. 2B, which is a schematic illustration showing an improved polarizer according to another preferred embodiment of the present invention. As seen in FIG. 2B, the retardation layer 230 is composed of a positive A-plate 235 and a positive C-plate 237. The positive A-plate 235 is made of tenacious materials that it can function as the supporting similar to the support layer 220 for supporting the polarizer 200.

Moreover, Instead of the positive A-plate 235, a dual-axial extending optical film made of tenacious materials can be used in the retardation layer 230 for providing supporting to the polarizer 200.

Let Nx be the refractive index in the X direction, Ny be the refractive index for in the Y direction and Nz be the refractive index in the Z direction, the optical characteristic of the positive A-plate 235 is as following:
Nx>Ny=Nz
(alternatively, the optical characteristic of the dual-axial extending optical film is as following: Nx>Ny>Nz)
and the optical characteristic of the positive C-plate is as following:
Nx=Ny<Nz
Hence, the positive C-plate is able to adjust the chromaticity shifting over the field of view generated while incident light passing through the polarizing layer 210 and the positive A-plate 235 (or the dual-axial extending optical film). That is, the reddish shifting is reduced while the incident light is further passing through the positive C-plate 235 after it passes through the polarizing layer 210 and the positive A-plate 235 (or the dual-axial extending optical film).

In addition, the light reflecting layer 240 can be a layer of UV-curable polyacrylate, which utilizes the characteristic of helix-aligned liquid for enabling the circularly polarized light with pitch the same as that of the liquid crystal to be recycled. Therefore, the light reflecting layer 240 not only can improve the brightness of light passing trough the polarizer 200, but also can enlarge the filed of view.

The advantages provided by the polarizer of the invention can be listed as following:
a. The positive A-plate of the retardation layer is capable of functioning as the supporting similar to the support layer for supporting the polarizer, such that the thickness and weight of the polarizer 200 are reduced effectively.
b. The positive C-plate is capable of correcting the chromaticity shifting while light passing through the polarizer so that the red-shift generated by the polarizer can be reduced.
c. The light reflecting layer of liquid crystal is capable of enabling the circularly polarized light with pitch the same as that of the liquid crystal to be recycled, such that not only the brightness of light passing trough the polarizer is improved, but also the filed of view is enlarged
d. Since the polarizer of the invention can improve the brightness and viewing angle of the LCD employing the same, the LCD can present an image of specific quality by using a comparative less power, such that the polarizer is capable of saving power consumption.

To sum up, the polarizer of the invention is primarily composed of a retardation layer and a light reflecting layer. Since the retardation layer is capable of providing support to the polarizer and correcting color shifting and the light reflecting layer is capable of enhancing brightness and enlarging viewing angle for an LCD employing the polarizer, the polarizer is not only thinner and lighter than a conventional polarizer, but it also have better brightness and viewing angle, and use less power.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A polarizer, comprising:
a polarizing layer, has a first surface and a second surface opposite to the first surface;
a support layer, disposed on the first surface of the polarizing layer;
a retardation layer, disposed on the second surface of the polarizing layer; and
a light reflecting layer, arranged on a surface of the retardation layer opposite to the surface of the retardation layer attaching to the polarizing layer.

2. The polarizer as recited in claim 1, wherein the support layer is a transparent substrate.

3. The polarizer as recited in claim 2, wherein the transparent substrate is a layer of triacetyl cellulose (TAC).

4. The polarizer as recited in claim 1, wherein the retardation layer further comprises:
a first retardation plate, arranged on a surface of the polarizing layer opposite to the surface of the polarizing layer attaching to the support layer; and
a second retardation plate, arranged on a surface of the first retardation plate opposite to the surface of the first retardation plate attaching to the polarizing layer;
wherein, the light reflecting layer is arranged on a surface of the second retardation layer opposite to the surface of the second retardation layer attaching to the first retardation plate.

5. The polarizer as recited in claim 4, wherein the first retardation plate is a positive A-plate.

6. The polarizer as recited in claim 4, wherein the first retardation plate is biaxial stretching film.

7. The polarizer as recited in claim 5, wherein the optical characteristic of the first retardation plate is Nx>Ny=Nz; and Nx represents the refractive index in the X direction, Ny represents the refractive index for in the Y direction and Nz represents the refractive index in the Z direction.

8. The polarizer as recited in claim 6, wherein the optical characteristic of the first retardation plate is Nx>Ny>Nz; and Nx represents the refractive index in the X direction, Ny represents the refractive index for in the Y direction and Nz represents the refractive index in the Z direction.

9. The polarizer as recited in claim 4, wherein the second retardation plate is a positive C-plate.

10. The polarizer as recited in claim 9, wherein the optical characteristic of the second retardation plate is Nx=Ny<Nz; and Nx represents the refractive index in the X direction, Ny represents the refractive index for in the Y direction and Nz represents the refractive index in the Z direction.

11. The polarizer as recited in claim 1, wherein the light reflecting layer is a layer of UV curable polyacrylate.
